(19) United States
(12) Patent Application Publication
(10) Pub. No.: US 2023/0127075 A1
(43) Pub. Date: Apr. 27, 2023

(54) Polyamide powder and corresponding preparation method

(71) Applicant: ARKEMA FRANCE, Colombes (FR)

(72) Inventors: Geoffroy CAMMAGE, Serquigny (FR); Benoît BRULE, Serquigny (FR)

(73) Assignee: ARKEMA FRANCE, Colombes (FR)

(21) Appl. No.: 17/798,227

(22) PCT Filed: Feb. 8, 2021
(86) PCT No.: PCT/FR2021/050225

§ 371 Date: Aug. 8, 2022

(30) Foreign Application Priority Data
Feb. 10, 2020 (FR) 2001287

(51) Int. Cl. C08L 77/06; C08G 69/04; C08J 3/14; B33Y 10/00; B33Y 70/00; B33Y 80/00; B29C 64/153

(52) U.S. Cl. CPC C08L 77/06; C08G 69/04; C08J 3/14; B33Y 10/00; B33Y 70/00; B33Y 80/00; B29C 64/153; B29K 2077/00

(57) ABSTRACT

The present invention relates to a polyamide powder having a high glass transition temperature and to the corresponding preparation method. The invention also relates to the articles made therefrom and to a method for the production thereof.

### TECHNICAL FIELD

The present invention relates to a polyamide powder having a high glass transition temperature, and also to the corresponding preparation process. The invention also relates to the articles manufactured from the powder, and also to their process of manufacture.

### TECHNICAL BACKGROUND

Compositions based on polyamide powder have very many applications in industry, in particular for the preparation of articles or parts of articles, for example for the automotive sector, the aeronautical sector, electrical and electronic components and consumer goods.

In particular, the compositions comprising polyamides are used as starting materials for the manufacture of articles or parts of articles by sintering, for example by laser sintering.

In order to facilitate the implementation of these processes and the manufacture of the corresponding articles, it is recommended to use compositions comprising polyamides in pulverulent form (polyamide powders). In addition, in order to improve the quality of the manufactured articles, it is recommended to use powders having selected characteristics, in particular in terms of size of the particles and of their distribution. In this respect, the polyamide powders obtained predominantly from units comprising cycloaliphatic diamines are particularly advantageous. Such powders exhibit a high glass transition temperature. This makes it possible to manufacture rigid articles having a greater temperature operating range. However, the polyamide powders currently available have a relatively low glass transition temperature, in particular of 50° C. or less, and the parts constructed with these powders thus have weak mechanical properties, in particular the Young's modulus, beyond this temperature. Furthermore, the use of available polyamide powders exhibits disadvantages due to the fouling of the items of equipment caused by their content of volatile residual compounds and of very fine particles.

The United States application US 2011/0070442 A1 discloses the preparation of a powder having a mean particle diameter of at least 0.5 μm and a narrow particle size distribution by dissolution and mixing of a first polymer and of a second polymer in an organic solvent in order to form an emulsion comprising a solution phase composed mainly of the first polymer and a solution phase composed mainly of the second polymer, and brought into contact with a poor solvent for the first polymer in order to cause it to precipitate (the second polymer having surfactant properties). Among the many compositions exemplified, examples 8, 12 and 13 disclose in particular polyamide powders exhibiting particles of small size, namely having respectively a mean diameter of 23.4 μm, 9.2 μm and 13.4 μm. However, it is not recommended to use, in additive manufacturing processes, powders having excessively small particle sizes, even with a narrow distribution, because they exhibit a poorer flow and foul the machines. Furthermore, the residual presence of the second polymer in these powders can have an impact on the quality of the manufactured articles.

The United States application US 2007/0232753 A1 discloses the preparation of a polymer powder by alloying with a water-soluble polymeric polyol, dissolution of the mixture in water to form a dispersion, and separation of the particles of the polymer from the dispersion. The examples disclose polyamide powders of spherical morphology but do not describe the size distribution of the particles. However, it is observed in this process that the distribution becomes wider as the mean diameter increases.

There is a need for polyamide powders having particles of satisfactory size and with a limited dispersion, in order to facilitate in particular the process of manufacture of the articles by sintering, to make possible high precision of execution and satisfactory reproducibility, and to improve the quality of the articles obtained, while avoiding the presence of excessively fine particles likely to foul the items of equipment.

### SUMMARY OF THE INVENTION

The invention relates first to a powder comprising at least one polyamide comprising at least one unit corresponding to the formula (Cₐ cycloaliphatic diamine).(C_{b} diacid); said powder having a glass transition temperature of at least 100° C.; and said powder being in the form of particles having a volume-average size of 35 to 120 μm, and the distribution of which is characterized by a ratio ((Dv₉₀−Dv₁₀)/Dv₅₀) of 2 or less.

In embodiments, the at least one polyamide comprises at least 50% by number of polyamide units corresponding to the formula (Cₐ cycloaliphatic diamine).(C_{b} diacid).

In embodiments, the Cₐ cycloaliphatic diamine comprises at least one substituted cycloaliphatic nucleus.

In embodiments, the Cₐ cycloaliphatic diamine comprises two nuclei of the cycloaliphatic type and corresponds to the general formula:

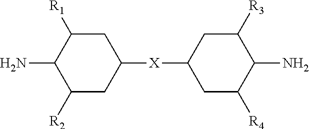

in which:

R₁, R₂, R₃ and R₄ independently represent a group chosen from a hydrogen atom or an alkyl comprising from 1 to 6 carbon atoms and X represents either a single bond or a divalent group consisting:

of a linear or branched aliphatic group comprising from 1 to 10 carbon atoms, optionally substituted by cycloaliphatic or aromatic groups comprising from 6 to 8 carbon atoms;

or of a cycloaliphatic group comprising from 6 to 12 carbon atoms. In embodiments, the Cₐ cycloaliphatic diamine is chosen from isophoronediamine, 1,2-cyclohexanediamine, 1,3-cyclohexanediamine, 1,4-cyclohexanediamine, 1,3-bis(aminomethyl)cyclohexane, 1,4-bis(aminomethyl)cyclohexane, methylcyclohexanediamine, norbornanediamine, bis(3-methyl-4-aminocyclohexyl)methane and 2,2′,4,4′-tetramethylcyclobutanediamine.

In embodiments, the C_{b} diacid is an aliphatic diacid, a cycloaliphatic diacid or an aromatic diacid.

In embodiments, the polyamide is a homopolyamide consisting of a repeat unit corresponding to the formula (Cₐ cycloaliphatic diamine).(C_{b} diacid). In embodiments, the polyamide is a copolyamide comprising, in addition to the unit corresponding to the formula (Cₐ cycloaliphatic diamine).(C_{b} diacid), at least one other unit, it being possible for said at least one other unit to be a unit obtained from an amino acid, a unit obtained from a lactam, a unit obtained from a diisocyanate and from a carboxylic acid, or a unit corresponding to the formula (C_{a′} diamine).(C_{b′} diacid), provided that the unit (C_{a′} diamine).(C_{b′} diacid) is different from the unit (Cₐ diamine).(C_{b} diacid). In embodiments, the polyamide is a crystallizable polyamide or a semi-crystalline polyamide.

In embodiments, the powder additionally comprises fillers, additives or their mixtures.

The invention relates secondly to a process for the manufacture of a powder as defined opposite, comprising the following stages: the provision of a composition comprising at least one polyamide comprising at least one unit corresponding to the formula (Cₐ cycloaliphatic diamine).(C_{b} diacid) as defined opposite, bringing said polyamide into contact with a solvent in order to obtain a homogeneous mixture, and the precipitation of the polyamide composition in the powder form.

In embodiments, the process additionally comprises a stage of drying the powder after the mixture has been cooled.

The invention relates thirdly to a process for the manufacture of an article by layer-by-layer sintering caused by electromagnetic radiation of the powder as defined opposite.

The invention relates fourthly to an article manufactured by layer-by-layer sintering caused by electromagnetic radiation starting from the powder as defined opposite.

The present invention makes it possible to overcome the disadvantages of the state of the art. It more particularly provides a powder making it possible to manufacture articles having unvarying and elevated mechanical properties (in particular the Young's modulus) at higher temperature, which makes it possible to manufacture rigid articles having a greater temperature operating range. It makes it possible in particular to provide polyamide powders having particles of satisfactory size and with a limited dispersion. These powders are particularly suitable for additive manufacturing, in particular by the sintering caused by electromagnetic radiation, such as laser sintering. It thus makes it possible to facilitate the process for the manufacture of the articles, in particular by sintering, to make possible high precision of execution and satisfactory reproducibility, and to improve the quality of the articles obtained. It additionally makes it possible to avoid the disadvantages inherent in powders comprising at least one polyamide, such as the obtaining of powder comprising undesirable residual compounds having a negative impact on the quality of the articles manufactured and the obtaining of excessively fine particles likely to foul the items of equipment.

### DETAILED DESCRIPTION

The invention is now described in greater detail and in a nonlimiting manner in the description which follows.

The term “powder” is understood to mean a composition in the form of divided particles and with a predetermined particle size distribution. The term “amorphous polyamide” is understood to mean a polyamide exhibiting only one glass transition temperature (without any endothermicity of fusion or exothermicity of crystallization) during the stages of cooling and heating at a rate of 20 K/min in differential scanning calorimetry measured according to the standard ISO 11357-2 of 2013.

The term “semi-crystalline polyamide” is understood to mean a polyamide exhibiting an enthalpy of crystallization (ΔH_{c}), during the stage of cooling at a rate of 20 K/min in differential scanning calorimetry, measured according to the standard ISO 11357-3 of 2013, of greater than 20 J/g, preferentially of greater than 30 J/g.

The term “crystallizable polyamide” is understood to mean a polyamide exhibiting an enthalpy of crystallization (ΔH_{c}), during the stage of cooling at a rate of 20 K/min in differential scanning calorimetry, measured according to the standard ISO 11357-3 of 2013, of 20 J/g or less; and exhibiting an enthalpy of cold crystallization (ΔH_{c}), during a stage of heating at a rate of 20 K/min in differential scanning calorimetry, measured according to the standard ISO 11357-3 of 2013, of greater than 0 J/g, preferentially of greater than 5 J/g, very preferentially of greater than 10 J/g, more preferentially of greater than 20 J/g.

The term “ambient temperature” is understood to mean a temperature of between 18 and 25° C., preferably approximately 20° C.

The term “spheroidal” is understood to mean quasispherical rounded particles. Spheroidal particles are particles without sharp edges, when they are observed by scanning electron microscopy, and exhibiting a mean form factor between the largest observable diameter and the smallest observable diameter of 1 to 2.

The ranges must be considered as limits included.

According to a first subject matter, the present invention relates to a powder comprising at least one polyamide comprising at least one unit obtained from a Cₐ cycloaliphatic diamine monomer, and more particularly a polyamide comprising at least one unit corresponding to the formula (Cₐ cycloaliphatic diamine).(C_{b} diacid);

said powder having a glass transition temperature of at least 100° C.; and said powder being in the form of particles, in particular of spheroidal particles, having a volume-average size between 35 and 120 μm, and a narrow dispersion in size of particles exhibiting a ratio ((Dv₉₀−Dv₁₀)/Dv₅₀) of 2 or less (where Dvₓ, is the size by volume of the X^{th} percentile).

The powder exhibits a glass transition temperature (Tg) of at least 100° C. The glass transition temperature (Tg) is measured by differential scanning calorimetry at a heating temperature of 20 K/min according to the standard ISO 11357-2 of 2013. Polyamide powders exhibiting a high glass transition temperature (Tg) are particularly advantageous. Such powders make it possible to manufacture articles which exhibit mechanical properties (in particular the Young's modulus) varying little with temperature and which can thus be used over a wider temperature range.

The powder is preferentially in the form of spheroidal particles, very preferentially in the form of spherical particles.

The polyamide particles have a volume-average size between 35 and 120 μm, preferentially between 40 and 80 μm. In some embodiments, the particles can have an average size between 35 and 40 μm; or between 40 and 45 μm; or between 45 and 50 μm; or between 50 and 55 μm; or between 55 and 60 μm; or between 60 and 65 μm; or between 65 and 70 μm; or between 70 and 75 μm; or between 75 and 80 μm; or between 80 and 85 μm; or between 85 and 90 μm; or between 90 and 95 μm; or between 95 and 100 μm; or between 100 and 105 μm; or between 105 and 110 μm; or between 110 and 115 μm; or between 115 and 120 μm. These dimensions are particularly suited to the manufacture of articles by layer-by-layer sintering. The presence of particles of smaller dimension is not recommended in that it can lead to fouling of the devices for the manufacture of said articles. In addition, the presence of particles of greater dimension is not desired because this reduces the definition of the articles obtained and for this reason their quality.

The polyamide particles have a particle size dispersion according to the formula (Dv₉₀−Dv₁₀)/Dv₅₀ of 2 or less. A narrow dispersion of the polyamide particles is recommended, both to limit, indeed even eliminate, the fouling of the devices for the manufacture of the articles by layer-by-layer sintering, in particular by laser sintering, and to facilitate the manufacture of said articles and to improve their quality.

The volume particle size distribution of the polyamide particles is determined according to a common technique, for example using a Coulter Counter III particle size analyzer, according to the standard ISO 13319. From the volume particle size distribution, it is possible to determine the volume-average diameter as well as the particle size dispersion (Dv₉₀−Dv₁₀)/Dv₅₀ which measures the width of the distribution.

The term Dv₅₀ designates the 50^{th} percentile of the distribution by volume of the sizes of particles, that is to say that 50% by volume of the particles have a size less than the Dv₅₀ and 50% by volume have a size greater than the Dv₅₀. It is the median of the volumetric distribution of the polyamide particles. The term Dv₁₀ designates the 10^{th} percentile of the distribution by volume of the sizes of particles, that is to say that 10% by volume of the particles have a size less than the Dv₁₀ and 90% by volume have a size greater than the Dv₁₀.

The term Dv₉₀ designates the 90^{th} percentile of the distribution by volume of the sizes of particles, that is to say that 90% by volume of the particles have a size less than the Dv₉₀ and 10% by volume have a size greater than the Dv₉₀.

In a specific embodiment, the polyamide particles have a monomodal particle size distribution.

The apparent specific surface (ASS) designates the ratio of the real surface area of a particle to the weight of this particle (comparable to the surface porosity). The polyamide particles preferentially have an apparent specific surface, measured according to the BET method, ranging from 1 to 50 m²/g, preferentially from 1 to 20 m²/g, very preferentially from 2 to 10 m²/g, more preferentially from 3 to 8 m²/g. The apparent specific surface is determined according to the international standard ISO 5794/1.

The powder comprises at least one polyamide comprising at least one unit corresponding to the formula (Cₐ cycloaliphatic diamine).(C_{b} diacid). The nomenclature used to define the polyamides is described in the standard ISO 16396-1:2015, “Plastics—Polyamide (PA) moulding and extrusion materials—Part 1: Designation system, marking of products and basis for specifications”.

Said polyamide comprises at least one unit corresponding to the formula (Cₐ cycloaliphatic diamine).(C_{b} diacid), with “a” representing the number of carbon atoms of the cycloaliphatic diamine and “b” representing the number of carbon atoms of the diacid, “a” and “b” each being independently between 4 and 36, as are defined below.

When the polyamide according to the invention is a homopolyamide, it comprises a single repeat unit corresponding to the formula (Cₐ cycloaliphatic diamine).(C_{b} diacid). The term “homopolyamide” is understood to mean a polyamide obtained from a single monomer or, in the case of a polyamide of the diamine.diacid type, from a single diamine and diacid pair. Such a homopolyamide then consists essentially of units corresponding to the formula (Cₐ cycloaliphatic diamine).(C_{b} diacid). The sum (a+b)/2 is preferentially greater than or equal to 8, very preferentially greater than or equal to 9, more preferentially greater than or equal to 10.

When the polyamide is a copolyamide, it comprises at least two distinct repeat units, one at least of the units of which corresponds to the formula (Cₐ cycloaliphatic diamine).(C_{b} diacid). The copolyamide preferably also comprises at least one other unit obtained from an amino acid, obtained from a lactam, obtained from a diisocyanate and from a carboxylic acid, or corresponding to the formula (C_{a′} diamine).(C_{b′} diacid), with “a′ ” representing the number of carbon atoms of the diamine and “b′ ” representing the number of carbon atoms of the diacid, “a′ ” and “b′ ” each being independently between 4 and 36, as are defined below. The sum (a′+b′)/2 is preferentially greater than or equal to 8, very preferentially greater than or equal to 9, more preferentially greater than or equal to 10.

The Cₐ cycloaliphatic diamine advantageously comprises at least one substituted cycloaliphatic nucleus, preferentially two substituted cycloaliphatic nuclei.

The Cₐ cycloaliphatic diamine can in particular be chosen from isophoronediamine, 1,2-cyclohexanediamine, 1,3-cyclohexanediamine, 1,4-cyclohexanediamine, 1,3-bis(aminomethyl)cyclohexane, 1,4-bis(aminomethyl)cyclohexane, methylcyclohexanediamine, norbornanediamine, bis(3-methyl-4-aminocyclohexyl)methane and 2,2′,4,4′-tetramethylcyclobutanediamine.

The Cₐ cycloaliphatic diamine can also comprise two nuclei of cycloaliphatic type and in particular correspond to the following general formula:

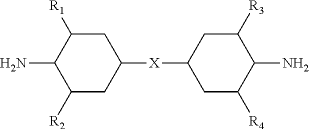

in which:

R₁, R₂, R₃ and R₄ independently represent a group chosen from a hydrogen atom or an alkyl comprising from 1 to 6 carbon atoms and;

X represents either a single bond or a divalent group consisting: of a linear or branched aliphatic group comprising from 1 to 10 carbon atoms, optionally substituted by cycloaliphatic or aromatic groups comprising from 6 to 8 carbon atoms; or

of a cycloaliphatic group comprising from 6 to 12 carbon atoms. More preferentially, the Cₐ cycloaliphatic diamine of the polyamide having two cycloaliphatic nuclei can be chosen from bis(3,5-dialkyl-4-aminocyclohexyl)methane, bis(3,5-dialkyl-4-aminocyclohexyl)ethane, bis(3,5-dialkyl-4 -aminocyclohexyl)propane, bis(aminocyclohexyl)propane (PACP) (2,2-bis(4-aminocyclohexyl)propane), bis(3,5-dialkyl-4-aminocyclohexyl)butane, bis(3- methyl-4-aminocyclohexyl)methane (denoted BMACM, MACM or B) or bis(p-aminocyclohexyl)methane (PACM). These last two diamines are generally provided in the form of a mixture of stereoisomers, and are described in particular in European application EP 0 725 101. More preferentially, the Cₐ cycloaliphatic diamine of the polyamide having two cycloaliphatic nuclei can be chosen from bis(3-methyl-4-aminocyclohexyl)methane (denoted BMACM, MACM or B) and bis(p- aminocyclohexyl)methane (PACM). The diamine PACM comprising at least 50% of trans-trans stereoisomer, referenced as PACM(50), is particularly preferred.

A non-exhaustive list of these Cₐ cycloaliphatic diamines is given in the publication “Cycloaliphatic Amines” (Encyclopaedia of Chemical Technology, Kirk-Othmer, 4th Edition (1992), pp. 386-405).

The C_{b} diacid can be an aliphatic diacid, a cycloaliphatic diacid or an aromatic diacid. When the diacid is an aliphatic C_{b} diacid, it can be straight or branched and saturated or unsaturated.

When the C_{b} diacid is aliphatic and linear, it can be chosen from succinic acid (b=4), pentanedioic acid (b=5), adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanoic acid (b=18), octadecenedioic acid (b=18), eicosanedioic acid (b=20), docosanedioic acid (b=22) and fatty acid dimers containing 36 carbons; preferentially from adipic acid (b=6), sebacic acid (b=10), dodecanedioic acid (b=12), tetradecanedioic acid (b=14) and octadecanoic acid (b=18). The abovementioned fatty acid dimers are dimerized fatty acids obtained by oligomerization or polymerization of unsaturated monobasic fatty acids having a long hydrocarbon chain (such as linoleic acid and oleic acid), as described in particular in the European patent application EP 0 471 566 A1. When the C_{b} diacid is an aromatic diacid, it can be chosen from terephthalic acid (commonly designated “T”), isophthalic acid (commonly designated “I”) and naphthalenic diacid.

When the C_{b} diacid is a cycloaliphatic diacid, it can comprise the following carbon backbones: norbornylmethane, cyclohexylmethane, dicyclohexylmethane, dicyclohexylpropane or di(methylcyclohexyl)propane. When the polyamide is a copolyamide, it additionally comprises at least one other unit than the unit corresponding to the formula (Cₐ cycloaliphatic diamine).(C_{b} diacid). Said at least one other unit can be a unit obtained from an amino acid, a unit obtained from a lactam, a unit obtained from a diisocyanate and from a carboxylic acid, or a unit corresponding to the formula (C_{a′} diamine).(C_{b′} diacid), provided that the unit (C_{a′} diamine).(C_{b′} diacid) is different from the unit (Cₐ diamine).(C_{b} diacid).

The copolyamide can additionally comprise at least one unit obtained from an amino acid chosen from 9-aminononanoic acid, 10-aminodecanoic acid, 12-aminododecanoic acid and 11-aminoundecanoic acid and also its derivatives, in particular N-heptyl-11-aminoundecanoic acid.

The copolyamide can additionally comprise at least one unit obtained from a lactam chosen from pyrrolidinone, piperidinone, caprolactam, enantholactam, caprylolactam, pelargolactam, decanolactam, undecanolactam, a monoterpene lactam and laurolactam; preferentially caprylolactam, pelargolactam, decanolactam, undecanolactam and laurolactam; very preferentially laurolactam.

The copolyamide can additionally comprise at least one other unit corresponding to the formula (C_{a′} diamine).(C_{b′} diacid), provided that the unit (C_{a′} diamine).(C_{b′} diacid) is different from the unit (Cₐ diamine).(C_{b} diacid). The C_{b} diacid can be chosen from the monomers C_{b} defined above. The C_{a′} diamine can be linear or branched aliphatic, cycloaliphatic or alkylaromatic.

When the C_{a′} diamine is a cycloaliphatic diamine, it can be chosen from the Cₐ diamines defined above. When the C_{a′} diamine is linear and aliphatic, it can be chosen from butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), octadecanediamine (a=18), eicosanediamine (a=20), docosanediamine (a=22) and diamines obtained from fatty acids. When the Cₐ' diamine is alkylaromatic, it can be chosen from 1,3-xylylenediamine, 1,4-xylylenediamine and their mixtures.

The polyamide comprising at least one unit corresponding to the formula (Cₐ cycloaliphatic diamine).(C_{b} diacid) can be chosen from PA BMACM.10, PA PACM.10, PA BMACM.12, PA PACM.12, PA BMACM.14, PA PACM.14, PA BMACM.18, PA PACM.18, PA 11/BMACM.10, PA 11/PACM.10, PA 11/BMACM.12, PA 11/PACM.12, PA 11/BMACM.14, PA 11/PACM.14, PA 11/BMACM.18, PA 11/PACM.18, PA 12/BMACM.10, PA 12/PACM.10, PA 12/BMACM.12, PA 12/PACM.12, PA 12/BMACM.14, PA 12/PACM.14, PA 12/BMACM.18, PA 12/PACM.18, PA 10.10/BMACM.10, PA 10.10/PACM.10, PA 10.10/BMACM.12, PA 10.10/PACM.12, PA 10.10/BMACM.14, PA 10.10/PACM.14, PA 10.10/BMACM.18, PA 10.10/PACM.18, PA 10.12/BMACM.10, PA 10.12/PACM.10, PA 10.12/BMACM.12, PA 10.12/PACM.12, PA 10.12BMACM.14, PA 10.12/PACM.14, PA 10.12/BMACM.18, PA 10.12/PACM.18, PA 12.10/BMACM.10, PA 12.10/PACM.10, PA 12.10/BMACM.12, PA 12.10/PACM.12, PA 12.10/BMACM.14, PA 12.10/PACM.14, PA 12.10/BMACM.18, PA 12.10/PACM.18, PA 12.12/BMACM.10, PA 12.12/PACM.10, PA 12.12/BMACM.12, PA 12.12/PACM.12, PA 12.12/BMACM.14, PA 12.12/PACM.14, PA 12.12/BMACM.18, PA 12.12/PACM.18, PA 10.14/PACM.10, PA 10.14/BMACM.12, PA 10.14/PACM.12, PA 10.14/BMACM.14, PA 10.14/PACM.14, PA 10.14/BMACM.18, PA 10.14/PACM.18, PA 12.14/BMACM.10, PA 12.14/PACM.10, PA 12.14/BMACM.12, PA 12.14/PACM.12, PA 12.14/BMACM.14, PA 12.14/PACM.14, PA 12.14/BMACM.18, PA 12.14/PACM.18, PA PACM.10/BMACM.10, PA PACM.12/BMACM.12, PA PACM.14/BMACM.14, PA 11/PACM.10/BMACM.10, PA 11/PACM.12/BMACM.12, PA 11/PACM.14/BMACM.14, PA 12/PACM.10/BMACM.10, PA 12/PACM.12/BMACM.12, or PA 12/PACM.14/BMACM.14, PA BMACM.I, PA PACM.I, PA BMACM.I/BMACM.T, PA PACM.I/PACM.T, PA BMACM.I/PACM.I, PA 12/BMACM.I, PA 12/PACM.I, PA 12/BMACM.I/BMACM.T, PA 12/PACM.I/PACM.T, PA 12/BMACM.I/PACM.I, PA 11/BMACM.I, PA 11/PACM.I, PA 11/BMACM.I/BMACM.T, PA 11/PACM.I/PACM.T, PA 11/BMACM.I/PACM.I, PA 10.10/BMACM.I, PA 10.10/PACM.I, PA 10.10/BMACM.I/BMACM.T, PA 10.10/PACM.I/PACM.T, PA 10.10/BMACM.I/PACM.I, PA 10.12/BMACM.I, PA 10.12/PACM.I, PA 10.12/BMACM.I/BMACM.T, PA 10.12/PA PACM.I/PACM.T, PA 10.12/BMACM.I/PACM.I, PA 12.10/BMACM.I, PA 12.10/PA PACM.I, PA 12.10/BMACM.I/BMACM.T, PA 12.10/PACM.I/PACM.T, PA 12.10/BMACM.I/PACM.I, PA 12.12/BMACM.I, PA 12.12/PACM.I, PA 12.12/BMACM.I/BMACM.T, PA 12.12/PACM.I/PACM.T, PA 12.12/BMACM.I/PACM.I, PA 12.14/BMACM.I, PA 12.14/PACM.I, PA 12.14/BMACM.I/BMACM.T, PA 12.14/PACM.I/PACM.T, PA 12.14/BMACM.I/PACM.I, PA 10.14/BMACM.I, PA 10.14/PACM.I, PA 10.14/BMACM.I/BMACM.T, PA 10.14/PACM.I/PACM.T, PA 10.14/BMACM.I/PACM.I or their mixtures.

Preferably, the polyamide can be chosen from PA BMACM.10, PA BMACM.12, PA BMACM.14, PA PACM.10, PA PACM.12, PA PACM.14, PA Z/BMACM.10, PA Z/BMACM.12, PA Z/BMACM.14, PA Z/BMACM.I, PA Z/BMACM.I/BMACM.T, PA Z/PACM.10, PA Z/PACM.12, PA Z/PACM.14, PA Z/PACM.I or PA Z/PACM.I/PACM.T in which Z represents 11, 12, 10.10 or 10.12. Advantageously, it can be chosen from the polyamides described in the patent application EP 1 595 907 A1 or in the application WO 2009/153534.

The polyamides of the Rilsan® Clear range from Arkema can in particular be used.

The polyamides of the Trogamid® range from Evonik can in particular be used, for example Trogamid® CX7323. Polyamides of the PA PACM.12 type which are disclosed in example 1 of the German application DE 4310970 are concerned.

The powder can additionally comprise at least one additional polyamide not comprising a unit corresponding to the formula (Cₐ cycloaliphatic diamine).(C_{b} diacid).

The additional polyamide can be a homopolyamide or a copolyamide. The polyamide can be a homopolyamide obtained by polymerization of an amino acid, of a lactam or comprising a unit corresponding to the formula (C_{a″} diamine).(C_{b″} diacid), the C_{a″} diamine not being a cycloaliphatic diamine.

The amino acid can be as defined above.

The lactam can be as defined above.

The C_{a″} diamine can be as defined above for the C_{a′} diamine, with the exception of the cycloaliphatic diamines.

The C_{b″} diacid can be as defined above for the C_{b} diacid.

The polyamide can be chosen from PA 11, PA 10.10, PA 10.12, PA 12.12, PA 10.14 or PA 12.14; preferentially PA 11 or PA 10.12; very preferentially PA 11.

The polyamide can comprise at least 50% by number of units obtained from cycloaliphatic diamines with respect to all of the units of the polyamide, that is to say at least 50% by number of units corresponding to the formula (cycloaliphatic diamine).(diacid)—as are defined above—with respect to all of the units of the polyamide. The cycloaliphatic diamines correspond to Cₐ cycloaliphatic diamines and to C_{a′} cycloaliphatic diamines (if present). The diacids correspond to C_{b} diacids and to C_{b′} diacids (if present). A high proportion of units corresponding to the formula (cycloaliphatic diamine).(diacid) in the polyamide makes it possible to increase the glass transition temperature (Tg) of the powder. In some embodiments, the polyamide comprises units corresponding to the formula (cycloaliphatic diamine).(diacid) present in a proportion by number, with respect to all of the units of the polyamide, of 50% to 55%; or of 55% to 60%; or of 60% to 65%; or of 65% to 70%; or of 70% to 75%; or of 75% to 80%; or of 80% to 85%; or of 85% to 90%; or of 90% to 95%; or of 95% to 100%. In some embodiments, the polyamide comprises units corresponding to the formula (cycloaliphatic diamine).(diacid) present in a proportion by number, with respect to all of the units of the polyamide, of at least 50%; or of at least 55%; or of at least 60%; or of at least 65%; or of at least 70%; or of at least 75%; or of at least 80%; or of at least 85%; or of at least 90%; or of at least 95%; or of at least 96%; or of at least 97%; or of at least 98%; or of at least 99%; or of at least 99.1%; or of at least 99.2%; or of at least 99.3%; or of at least 99.4%; or of at least 99.5%; or of at least 99.6%; or of at least 99.7%; or of at least 99.8%; or of at least 99.9%.

In one embodiment, the powder does not comprise an additional polyamide. In some embodiments, the powder comprising at least 50% of units corresponding to the formula (Cₐ cycloaliphatic diamine).(C_{b} diacid) is homogeneously mixed with another polyamide powder in a proportion by weight of 5% to 10%; or of 10% to 15%; or of 15% to 20%; or of 20% to 25%; or of 25% to 30%; or of 30% to 35%; or of 35% to 40%; or of 40% to 45%; or of 45% to 50%; or of 50% to 55%; or of 55% to 60%; or of 60% to 65%; or of 65% to 70%; or of 70% to 75%; or of 75% to 80%; or of 80% to 85%; or of 85% to 90%; or of 90% to 95%; or of 95% to 96%; or of 96% to 97%; or of 97% to 98%; or of 98% to 99%; or of 99% to 99.1%; or of 99.1% to 99.2%; or of 99.2% to 99.3%; or of 99.3% to 99.4%; or of 99.5% to 99.6%; or of 99.7% to 99.8%; or of 99.8% to 99.9%, based on the total weight of the powder.

The polyamides according to the present invention can be amorphous polyamides, crystallizable polyamides or semicrystalline polyamides; preferably crystallizable polyamides or semicrystalline polyamides.

The powder can additionally comprise fillers. The fillers can be chosen from conventional inorganic fillers, such as those chosen from the group, given without limitation, comprising talc, kaolin, magnesia, slag, silica, carbon black, carbon nanotubes, expanded or nonexpanded graphite, titanium oxide and glass, in particular in the form of beads or fibers.

The powder can comprise from 10% to 60%, preferably from 20% to 50%, by weight of fillers, with respect to the total weight of the powder.

The composition can also additionally comprise additives customary in powders, such as: flow agents, nucleating agents, dyes, light (UV) and/or heat stabilizers, plasticizers, surface-active agents, pigments, optical brighteners, antioxidants, waxes or their mixtures.

The usual stabilizers used with polymers are phenols, phosphites, UV absorbers, stabilizers of the HALS (Hindered Amine Light Stabilizer) type or metal iodides. Mention may be made of Irganox 1010, 245 or 1098, Irgafos 168 or 126, Tinuvin 312 or 770, Iodide P201 from Ciba or Nylostab S-EED from Clariant.

The powder can comprise 10% by weight or less, preferentially less than 5%, of additives, with respect to the total weight of the powder. The powder may in addition be substantially devoid of any surfactant compound.

The term “substantially” is understood to mean a powder comprising 1% or less, preferentially 0.1% or less, very preferentially 0.01% or less, more preferentially approximately 0%, of a compound by weight, with respect to the total weight of the powder.

The powder is particularly suitable for the manufacture of articles by sintering. The powder is particularly suitable also for other applications, in particular its use for manufacturing composite materials; multilayer materials; transfer papers; coatings of substrates, for example metal substrates; compositions of inks or paints; cosmetic or pharmaceutical compositions; electrophoresis gels; packaging; articles intended for the transfer of fluid, for example piping, or pump or valve accessories; automotive articles, for example in the form of a splined shaft, a sliding door rail or a spring; articles made of yarns, for example a dishwasher basket; articles obtained by compression, sintering or melting, for example by using infrared radiation, ultraviolet radiation or a laser beam.

According to a second subject matter, the present invention relates to a process for the manufacture of a powder according to the first subject matter of the present invention. This process is based on the principle of dissolution/precipitation.

The process comprises the following stages:

The provision of a composition comprising at least one polyamide comprising at least one unit corresponding to the formula (Cₐ cycloaliphatic diamine).(C_{b} diacid);

bringing said polyamide into contact with a solvent in order to obtain a homogeneous mixture;

the precipitation of this polyamide composition in the powder form. The polyamide comprising at least one unit corresponding to the formula (Cₐ cycloaliphatic diamine).(C_{b} diacid) is as defined above. The composition (starting material) can be prepared by any conventional method which makes it possible to obtain a mixture of homogeneous distribution of the polyamide comprising at least one unit corresponding to the formula (Cₐ cycloaliphatic diamine).(C_{b} diacid), optionally additional polyamides, and optionally additives and/or fillers. The preparation process can be melt extrusion, compaction, a method using a roll mill, or any other suitable method. In particular, the composition can be prepared by melt blending all the ingredients in a “direct” process. The composition can also be prepared by dry blending.

The solvent, which is brought into contact with the polyamide composition, can be chosen from an alcohol, such as ethanol, propanol, butanol, isopropanol or heptanol; a carboxylic acid, such as formic acid or acetic acid; a nitrogen compound, such as N-methylpyrrolidone or N-butylpyrrolidone; or also a lactam, such as butyrolactam or caprolactam, or any one of their mixtures.

The polyamide composition can have a fraction by weight in the solvent of 0.05 to 0.5, preferentially of 0.1 to 0.3, for example of 0.2. In some embodiments, the composition can in particular have a fraction by weight of 0.05 to 0.1; or of 0.1 to 0.15; or of 0.15 to 0.2; or of 0.2 to 0.25; or of 0.25 to 0.3; or of 0.3 to 0.35; or of 0.35 to 0.4; or of 0.4 to 0.45; or of 0.45 to 0.5. The operation of bringing into contact in order to obtain a homogeneous mixture can be carried out by heating the mixture up to a temperature greater by at least 20° C. with respect to the glass transition temperature of the polyamide composition. Heating the mixture contributes to the dissolution of the polyamide composition in the solvent.

The operation of bringing into contact in order to obtain a homogeneous mixture can be carried out at ambient temperature, before a gradual rise in temperature up to the desired temperature.

The operation of bringing into contact in order to obtain a homogeneous mixture can be carried out with stirring, in particular with mechanical stirring, in order to promote homogenization and dissolution.

The heating of the mixture can be carried out at a temperature of at least 120° C., preferentially between 140° C. and 250° C., very preferentially between 170° C. and 200° C.

Once the target temperature (T° C. target) is reached, it will remain essentially constant for a period of 30 minutes to 6 hours; preferentially of 30 min to 3 h. In some embodiments, the heating can be carried out for a period of 30 min to 1 h; or of 1 h to 1 h 30; or of 1 h 30 to 2 h; or of 2 h to 2 h 30; or of 2 h 30 to 3 h; or of 3 h to 3 h 30; or of 3 h 30 to 4 h; or of 4 h to 4 h 30; or of 4 h 30 to 5 h; or of 5 h to 5 h 30; or of 5 h 30 to 6 h.

The polyamide composition is subsequently precipitated from the mixture, for example by controlled cooling. Cooling can be carried out down to ambient temperature.

The cooling can be carried out at a rate of 10 to 100° C. per hour; preferentially of 10 to 70° C. per hour; very preferentially of 40 to 60° C. per hour. In some embodiments, the cooling can be carried out at a rate of 10 to 15° C. per hour; or of 15 to 20° C. per hour; or of 20 to 25° C. per hour; or of 25 to 30° C. per hour; or of 30 to 35° C. per hour; or of 35 to 40° C. per hour; or of 40 to 45° C. per hour; or of 45 to 50° C. per hour; or of 50 to 55° C. per hour; or of 55 to 60° C. per hour; or of 60 to 65° C. per hour; or of 65 to 70° C. per hour; or of 70 to 75° C. per hour; or of 75 to 80° C. per hour; or of 80 to 85° C. per hour; or of 85 to 90° C. per hour; or of 90 to 95° C. per hour; or of 95 to 100° C. per hour.

The cooling stage can additionally comprise a stationary phase during which the temperature will remain essentially constant for a period of 30 min to 6 h, preferentially of 2 to 5 h.

In a specific embodiment, the polyamide powder thus obtained exhibits a monomodal particle size distribution.

The powder is subsequently separated from the solvent by one of the solid-liquid separation means known to a person skilled in the art.

The process can subsequently comprise a stage of drying the powder thus obtained. The drying can be carried out by any suitable method. For example, the drying stage can be carried out in an oven.

The drying can be carried out at a temperature of 10 to 150° C.; preferentially of 25 to 85° C.; very preferentially of 70 to 80° C., for example at 75° C. In some embodiments, the drying can be carried out at a temperature of 10 to 15° C.; or of 15 to 20° C., or of 20 to 25° C., or of 25 to 30° C., or of 30 to 35° C., or of 35 to 40° C., or of 40 to 45° C., or of 45 to 50° C.; or of 50 to 55° C.; or of 55 to 60° C., or of 60 to 65° C., or of 65 to 70° C., or of 70 to 75° C., or of 75 to 80° C., or of 80 to 85° C., or of 85 to 90° C., or of 90 to 95° C., or of 95 to 100° C.; or of 100 to 105° C., or of 105 to 110° C., or of 110 to 115° C., or of 115 to 120° C., or of 120 to 125° C.; or of 125 to 130° C.; or of 130 to 135° C.; or of 135 to 140° C.; or of 140 to 145° C.; or of 145 to 150° C.

The drying can be carried out under vacuum at a pressure of 10 to 1000 mbar; preferentially of 50 to 1000 mbar. In some embodiments, the drying can be carried out at a pressure of 10 to 50 mbar; or of 50 to 100 mbar; or of 100 to 150 mbar; or of 150 to 200 mbar; or of 200 to 250 mbar; or of 250 to 300 mbar; or of 300 to 350 mbar; or of 350 to 400 mbar; or of 400 to 450 mbar; or of 450 to 500 mbar; or of 500 to 550 mbar; or of 550 to 600 mbar; or of 600 to 650 mbar; or of 650 to 700 mbar; or of 700 to 750 mbar; or of 750 to 800 mbar; or of 800 to 850 mbar; or of 850 to 900 mbar; or of 900 to 950 mbar; or of 950 to less than 1 bar. Alternatively, the drying can be carried out under atmospheric pressure.

The additives as described above can be added during the providing of the powder, during the operation of bringing into contact with the solvent or after the precipitation.

According to a third subject matter, the present invention relates to a process for the sintering of the polyamide powder.

The powder, as described above, is used for a process for the manufacture of articles by layer-by-layer sintering caused by electromagnetic radiation.

The electromagnetic radiation can, for example, be infrared radiation, ultraviolet radiation or laser radiation, preferentially laser radiation. Preferably, it is a process by layer-by-layer sintering caused by laser radiation (laser sintering).

According to this process, a thin layer of powder is deposited on a horizontal plate maintained in a chamber heated to a temperature called the build temperature. This temperature must be lower than the melting point of the polyamide but sufficiently high to make it possible for it to melt when it receives the electromagnetic radiation. The electromagnetic radiation subsequently contributes the energy necessary to sinter the powder particles at different points of the powder layer according to a geometry corresponding to an object (for example using a computer having in memory the shape of an object and recreating the latter in the form of slices).

Subsequently, the horizontal plate is lowered by a value corresponding to the thickness of a powder layer, and a fresh layer is deposited. The electromagnetic radiation contributes the energy necessary to sinter the powder particles according to a geometry corresponding to this new slice of the object, and so on. The procedure is repeated until the object has been manufactured.

The present invention thus also relates to the use of the polyamide powder for obtaining an article by layer-by-layer sintering of the powder caused by electromagnetic radiation.

According to a fourth subject matter, the present invention relates to an article manufactured by layer-by-layer sintering caused by electromagnetic radiation starting from the powder as defined above.

### EXAMPLE

The following example illustrates the invention without limiting it.

In this example, three types of polyamides are used:

Polyamide 12 (comparative) sold under the name Rilsamid® AECNO TL by Arkema with a glass transition temperature (Tg) of 40° C.

A polyamide BMACM.14 (invention) with a glass transition temperature (Tg) of 145° C.

The polyamide PACM.12 (invention) sold under the name Trogamid® CX7323 by Evonik with a glass transition temperature (Tg) of 140° C.

5 g of polyamide granules and 25 g of industrial-grade ethanol (solids content of the dispersion =17% by weight) are charged at ambient temperature and at atmospheric pressure to an autoclave fitted with a propeller-type stirrer. The granules and the ethanol are mixed with stirring of 400 revolutions/minute and heated using a removable oven up to the target temperature; this heating induces an increase in the pressure in the reactor (at 145° C., P=9 bar absolute and, at 190° C., P=26 bar absolute). The temperature is maintained for 1 h. Subsequently, the oven is removed from the reactor in order to make possible gradual cooling down to ambient temperature, in order to make possible crystallization. The powder is recovered and then dried in a hot cabinet at 75° C. under atmospheric pressure. The powders obtained are analyzed and the results are described in detail in the table below.

| | | | | Temp, | | |
|---|---|---|---|---|---|---|
| | | | | process | Average | (DV₉₀ − |
| | | Tg | | Target | size | DV₁₀)/ |
| Tests | Polyamide | (° C.) | Type | (° C.) | (μm) | DV₅₀ |
| 1 | PA 12 | 40 | Semi-cris. | 145 | 58.9 | 1.05 |
| | | | (ΔH_{c} = 68 | | | |
| | | | J/g) | | | |
| 2 | BMACM.14 | 145 | Amorphous | 145 | ND | ND |
| 3 | BMACM.14 | 145 | Amorphous | 190 | 87.9 | 0.97 |
| 4 | PACM.12 | 140 | Cristallizable | 190 | 63.2 | 1.65 |
| | | | (ΔH_{cc} = 16 | | | |
| | | | J/g) | | | |

The results obtained with a process and a polyamide according to the invention (tests 3 and 4) are compared with the results obtained with a comparative process (test 2, where the heating temperature is not greater by at least 20° C., with respect to the glass transition temperature of the polyamide) and with a comparative polyamide (test 1, where the polyamide does not have a glass transition temperature of at least 100° C.).

Tests 1, 3 and 4 resulted in a polyamide powder being obtained, unlike test 2, in which the polyamide granules were not dissolved, and thus no powder is obtained. In addition, the powders of tests 3 and 4 obtained following the invention will result in parts having unvarying and elevated mechanical properties (in particular the Young's modulus) at higher temperature (especially for temperatures greater than the glass transition temperature of the polyamide of test 1).

Particle size analysis has demonstrated that the process and the polyamides according to the invention having a glass transition temperature of at least 100° C. made it possible to obtain polyamide powders having a volume-average size of 35 to 120 μm and a distribution characterized by a ratio ((Dv₉₀−Dv₁₀)/Dv₅₀) of 2 or less.

1. A powder comprising at least one polyamide comprising at least one unit corresponding to the formula (Ca cycloaliphatic diamine).(Cb diacid);
said powder having a glass transition temperature of at least 100° C.; and
said powder being in the form of particles having a volume-average size of 35 to 120 μm, and the distribution of which is characterized by a ratio ((Dv90−Dv10)/Dv50) of 2 or less.

2. The powder as claimed in claim 1, in which the at least one polyamide comprises at least 50% by number of polyamide units corresponding to the formula (Ca cycloaliphatic diamine).(Cb diacid).

3. The powder as claimed in claim 1, in which the Ca cycloaliphatic diamine comprises at least one substituted cycloaliphatic nucleus.

4. The powder as claimed in claim 1, in which the Ca cycloaliphatic diamine comprises two nuclei of cycloaliphatic type and corresponds to the general formula: 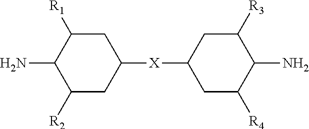
in which:
R1, R2, R3 and R4 independently represent a group chosen from a hydrogen atom or an alkyl comprising from 1 to 6 carbon atoms and;
X represents either a single bond or a divalent group consisting:
of a linear or branched aliphatic group comprising from 1 to 10 carbon atoms, optionally substituted by cycloaliphatic or aromatic groups comprising from 6 to 8 carbon atoms; or
of a cycloaliphatic group comprising from 6 to 12 carbon atoms.

5. The powder as claimed in claim 1, in which the Ca cycloaliphatic diamine is chosen from isophoronediamine, 1,2-cyclohexanediamine, 1,3-cyclohexanediamine, 1,4-cyclohexanediamine, 1,3-bis(aminomethyl)cyclohexane, 1,4-bis(aminomethyl)cyclohexane, methylcyclohexanediamine, norbornanediamine, bis (3-methyl-4-aminocyclohexyl)methane and 2,2′,4,4′-tetramethylcyclobutanediamine.

6. The powder as claimed in claim 1, in which the Cb diacid is an aliphatic diacid, a cycloaliphatic diacid or an aromatic diacid.

7. The powder as claimed in claim 1, in which the polyamide is a homopolyamide consisting of a repeat unit corresponding to the formula (Ca cycloaliphatic diamine).(Cb diacid).

8. The powder as claimed in claim 1, in which the polyamide is a copolyamide comprising, in addition to the unit corresponding to the formula (Ca cycloaliphatic diamine).(Cb diacid), at least one other unit, it being possible for said at least other unit to be a unit obtained from an amino acid, a unit obtained from a lactam, a unit obtained from a diisocyanate and from a carboxylic acid, or a unit corresponding to the formula (Ca′ diamine).(Cb′ diacid), provided that the unit (Ca′ diamine).(Cb′ diacid) is different from the unit (Ca diamine).(Cb diacid).

9. The powder as claimed in claim 1, in which the at least one polyamide is a crystallizable polyamide or a semicrystalline polyamide.

10. The powder as claimed in claim 1, additionally comprising fillers, additives or their mixtures.

11. A process for the manufacture of a powder as claimed in claim 1, comprising the following stages:
the provision of a composition comprising at least one polyamide comprising at least one unit corresponding to the formula (Ca cycloaliphatic diamine).(Cb diacid);
bringing said polyamide into contact with a solvent in order to obtain a homogeneous mixture;
the precipitation of the polyamide composition in the powder form.

12. The process for the manufacture of a powder as claimed in claim 11, said process additionally comprising a stage of drying the polyamide powder after the mixture has been cooled.

13. A process for the manufacture of an article by layer-by-layer sintering caused by electromagnetic radiation of the powder as claimed in claim 1.

14. An article manufactured by layer-by-layer sintering caused by electromagnetic radiation starting from the powder as claimed in claim 1.
